(19) United States
(12) Patent Application Publication
(10) Pub. No.: US 2026/0331116 A1
(43) Pub. Date: Oct. 22, 2026

(54) MULTIMODAL AUDIO CHANNEL CLASSIFICATION

(71) Applicant: Disney Enterprises, Inc., Burbank, CA (US)

(72) Inventor: Patrick GAVIN, Larkspur, CA (US)

(21) Appl. No.: 19/184,960

(22) Filed: Apr. 21, 2025

(51) Int. Cl. G10L 19/04; G06V 20/40; G06V 20/62; G06V 30/10

(52) U.S. Cl. CPC G10L 19/04; G06V 20/46; G06V 20/63; G06V 30/10

(57) ABSTRACT

Embodiments provide for multimodal audio channel classification. Audio data comprising a set of channels is accessed, and a set of spectrograms comprising a respective spectrogram for each respective channel of the set of channels is generated. An initial set of channel classifications is generated based on, for each respective channel of the set of channels, processing the respective spectrogram using a channel classification machine learning model. A revised set of channel classifications is generated based on evaluating the initial set of channel classifications using a set of channel rules. The revised set of channel classifications is output.

### BACKGROUND

There are a wide variety of encoding and formatting configurations in common use today for media files (including audio files, video files, or multimedia files including both audio and video). For example, audio is often stored or provided as a set of channels, where each channel may have distinct portions of the desired audio output. However, there are many different common channel configurations. That is, the particular audio that is assigned to any particular channel may vary widely. For example, channel configurations may include mono (e.g., a single channel, or the same audio data on each channel), stereo (e.g., with a left and a right channel), 2.1 (e.g., stereo plus a subwoofer channel), 5.1 (e.g., five full-bandwidth channels and a subwoofer channel), and the like.

Often, video and audio files may be received from various sources (including international versions), and it may be unclear whether any the files follow the same specification requirements for audio formatting. However, a wide variety of downstream processes (e.g., encoding or re-encoding the file for storage, streaming, and the like) rely on dependable audio formatting. When the audio format of a given file is unknown or cannot be trusted, these downstream operations can encounter numerous errors. However, given the variety of possible configurations, there are no adequate techniques available to automatically perform channel classification.

### BRIEF DESCRIPTION OF THE DRAWINGS

So that the manner in which the above recited aspects are attained and can be understood in detail, a more particular description of embodiments described herein, briefly summarized above, may be had by reference to the appended drawings.

It is to be noted, however, that the appended drawings illustrate typical embodiments and are therefore not to be considered limiting; other equally effective embodiments are contemplated.

FIG. 1 depicts an example system for automatic channel classification, according to some embodiments of the present disclosure.

FIG. 2 depicts an example workflow for automatic audio channel classification, according to some embodiments of the present disclosure.

FIG. 3 is a flow diagram depicting an example method for automatic audio channel classification, according to some embodiments of the present disclosure.

FIG. 4 is a flow diagram depicting an example method for machine learning-based channel classification, according to some embodiments of the present disclosure.

FIG. 5 is a flow diagram depicting an example method for channel classification, according to some embodiments of the present disclosure.

FIG. 6 depicts an example computing device configured to perform various embodiments of the present disclosure.

### DETAILED DESCRIPTION

Embodiments of the present disclosure provide techniques for channel classification. In some embodiments, a multimodal approach can be used to automatically determine the audio formatting of input audio files by classifying the audio channels using a variety of operations.

In some embodiments, audio classification is performed using an audio classification machine learning model, a rules engine (e.g., a heuristics-based evaluation), and a language model (e.g., a large language model (LLM)) to generate and refine channel classifications. For example in some embodiments, the audio data within each channel of audio may be evaluated using the classification machine learning model to generate an initial channel classification. This set of initial classifications can then be evaluated using the rules engine to refine or modify the initial classifications in accordance with various rules (e.g., to ensure that the initial predictions align with one or more of a set of predefined audio formats).

In some embodiments, if any channels have unknown classification after this rules evaluation, a language model may be used to evaluate corresponding text associated with the audio file (e.g., a title card or slate included in a video file that accompanies the audio) in order to generate revised channel predictions. In some embodiments, after using the language model to generate revised predictions, the revised predictions may again be analyzed using the rules-based evaluation (potentially modifying the revised predictions) to generate a set of final channel classifications for the audio channel(s) included in the input audio.

Generally, this output audio may then be used for a variety of downstream operations or processes. For example, a new encoded version of the audio, video, or both may be generated (according to any desired encoding format) based on the determined audio channel classifications. If the channel classifications are not known (or are inaccurate), such downstream tasks may result in a variety of errors (e.g., resulting in encoded files with audio glitches or missing audio, or resulting in the encoding process itself failing). Accordingly, embodiments of the present disclosure can enable improved audio processing and transcoding, in addition to a variety of other downstream operations.

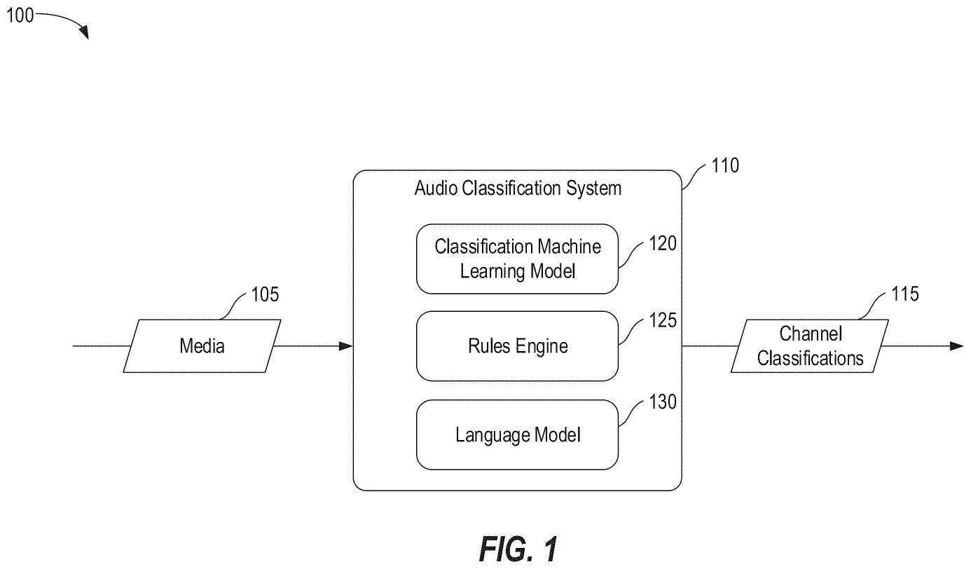

FIG. 1 depicts an example system 100 for automatic channel classification, according to some embodiments of the present disclosure.

In the illustrated system 100, an audio classification system 110 accesses media 105 and generates a set of channel classifications 115. As used herein, “accessing” data may generally include receiving, requesting, retrieving, collecting, generating, or otherwise gaining access to the data. For example, the audio classification system 110 may receive the media 105 from another system or entity (e.g., as input from a user, from a storage repository, or from another system that generated the media 105). Although depicted as a discrete system for conceptual clarity, the operations of the audio classification system 110 may generally be combined or distributed across any number of systems and devices, and may be implemented using hardware, software, or a combination of hardware and software.

The media 105 is generally representative of any media file that includes at least an audio component. For example, the media 105 may include audio data only, audio data and video data (e.g., a video with sound), and the like. The media 105 may generally be formatted or encoded according to any suitable format. In particular, the audio data of the media 105 may use any audio channel formatting (e.g., any given audio channel(s) may include any component of the audio data). In some aspects, the media 105 may include or be associated with a label indicating the audio formatting. For example, the formatting may be included or specified in the media 105 itself (e.g., as a title or slate card).

Generally, the labeling (if any) may include a per-channel label indicating the particular audio component of each channel or a format label indicating a predefined channel formatting. For example, the label may specify that the audio is formatted in 5.1 surround sound, indicating that the audio includes six channels in a specified order (which may depend on the file format of the media 105), such as left (L), right (R), center (C), low frequency effects (LFE or subwoofer), surround left (Ls), and surround right (Rs). As another example, the label may indicate that the first channel is stereo left and the second channel is stereo right.

However, as discussed above, the indicated format of the audio may be inaccurate in a wide variety of realistic environments. For example, the author of the label may simply have misunderstood or mistaken the format. As another example, the format may have been changed subsequent to the initial creation of the media 105.

In the illustrated system 100, therefore, the audio classification system 110 may analyze the media 105 using a multimodal approach to generate a set of channel classifications indicating the audio content of each channel of audio data in the media 105. In some embodiments, the channel classifications may include per-channel classifications (e.g., indicating that channel 1 is stereo left and channel 2 is stereo right), may include specified channel formatting (e.g., indicating that the audio is formatted in 7.1), or both.

In the illustrated example, the audio classification system 110 includes a classification machine learning model 120, a rules engine 125, and a language model 130. Although depicted as discrete components for conceptual clarity, in some embodiments, the classification machine learning model 120, the rules engine 125, and the language model 130 may be combined or distributed across any number of components.

In some embodiments, the classification machine learning model 120 generally comprises a machine learning model trained to classify input audio data based on what audio channel the audio corresponds to. For example, based on the subset of audio data provided on a given channel, the classification machine learning model 120 may classify the given channel into one of a set of audio channel definitions, such as one of the 5.1 format channels (e.g., 5.1 Left, 5.1 Right, 5.1 Center, 5.1 LFE, 5.1 Left Surround, or 5.1 Right Surround), a stereo (e.g., 2.0) channel (e.g., 2.0 Left or 2.0 Right), a dialogue channel (e.g., a channel used for dialogue in the media 105), a special effects (SFX) channel (e.g., a channel used for special effects in the media 105), a music channel (e.g., Music Left or Music Right), a mono mix channel (e.g., audio mixed to a single channel), a mono mix with AD channel (also referred to as a mono AD mix channel), a “motor only shot” or “mit-out sound” (MOS) channel (e.g., a channel with no audio data or sound), and the like. As additional examples, the classification machine learning model 120 may generally classify the input channels based on a wide variety of audio formatting, such as into 5.1 Dia (e.g., 5.1 audio optimized or intended for dialogue or general audio), 5.1 Music and Effects (e.g., 5.1 audio optimized or intended for use with music data, effects data, or both), 7.1 Dia, 7.1 Music and Effects, and the like.

In some embodiments, as discussed in more detail below, the audio classification system 110 may generate one or more spectrograms for the audio data in a given channel, and use this spectrogram as input to the classification machine learning model 120 to generate the channel classification. In some embodiments, the audio classification system 110 may delineate the audio data for a given channel into a set of segments (e.g., five segments that are thirty seconds long each), generate a corresponding spectrogram for each segment, and generate a corresponding prediction based on each spectrogram. These predictions may then be aggregated to generate an overall classification for the channel (e.g., based on majority voting), as discussed below in more detail.

In some embodiments, given a set of initial channel classifications generated by the classification machine learning model 120, the rules engine 125 may apply one or more predefined rules or heuristics to determine whether each initial classification is plausible (e.g., may be correct) or incorrect (e.g., because the initial classification violates one of the rules). In some embodiments, the rule(s) used by the rules engine 125 may be defined based on a set of known or defined audio formats that the audio classification system 110 is configured to identify. In some embodiments, based on these evaluations, the rules engine 125 may optionally modify one or more of the predictions.

For example, if multiple channels are classified as mono mix (e.g., a composite of all audio combined into one channel), the rules engine 125 may determine that at least one of these classifications is incorrect (as there may generally be only a single mono channel), and may therefore set one or more of the mono channels to an “unknown” classification.

As another example, if two adjacent channels are both classified as stereo channels (e.g., both stereo left, both stereo right, or one of each), the rules engine 125 may determine that the two channels may plausibly be classified as stereo (e.g., with the first channel being assigned stereo left and the subsequent channel being assigned stereo right).

As yet another example, if several adjacent channels (e.g., six channels) are all designated as one of the 5.1 channels, the rules engine 125 may infer that these are, in fact, 5.1 formatted and therefore correct any mislabeling (e.g., if two are labeled as 5.1 left) based on the predefined order of 5.1 channels. However, if only a single channel is classified as 5.1 (but the surrounding channels are not), the rules engine 125 may infer that the single channel has been misclassified and may therefore mark this channel as “unknown.”

As yet another example, the rules engine 125 may determine that some classifications should only be applied to some channels (e.g., because by convention the corresponding type of audio is always or nearly always located in such channels), such as specifying that the “dialogue” channel (if any) should be channel 1 or channel 9, that the “special effects” channel (if any) should be channel 2 or channel 10, and the like. Generally, a wide variety of heuristics or rules-based evaluations may be used depending on the particular implementation.

In some embodiments, the rules engine 125 can therefore output a set of revised or modified channel classifications (which may correspond to the initial classifications generated by the classification machine learning model, with zero or more modifications).

In the illustrated example, if any of the revised channel classifications are “unknown,” the language model 130 may be used to further revise or modify the revised channel classifications. In some embodiments, if the media 105 includes one or more labels indicating the (purported) audio formatting, the language model 130 may be used to evaluate these labels and assign the indicated classification to any “unknown” channels. For example, if the label indicates that channel 9 corresponds to “dialogue,” the language model 130 may revise the “unknown” classification for channel 9 to a “dialogue” classification.

In some embodiments, as discussed in more detail below, the audio classification system 110 may identify and extract any label text for the media 105 (e.g., from a title card) and may provide this text as input context to the language model 130. The language model 130 may then be prompted to generate a classification for any “unknown” channels based on the context (e.g., querying the language model 130 what the classification for channel 6 should be).

In some embodiments, after the language model 130 further revises or modifies the revised channel classifications, these further revised classifications may again be evaluated using the rules engine 125 to verify whether each is plausible or inherently implausible or incorrect.

In the illustrated example, based on this second rules evaluation, the audio classification system 110 generates and outputs a final set of channel classifications 115 for the media 105. In some embodiments, the channel classifications 115 may still include one or more “unknown” labels. However, generally, the channel classifications 115 include more accurate and reliable channel labels than provided by conventional solutions (including those specifically indicated in the media 105 itself, as discussed above).

As discussed above, these channel classifications 115 can then be used to facilitate or enable a variety of downstream processes, such as re-encoding (e.g., transcoding), reformatting the media 105 (or portions thereof), or both for various purposes (e.g., for storing, streaming, or both storing and streaming of the audio data, video data, or combined audio and video data).

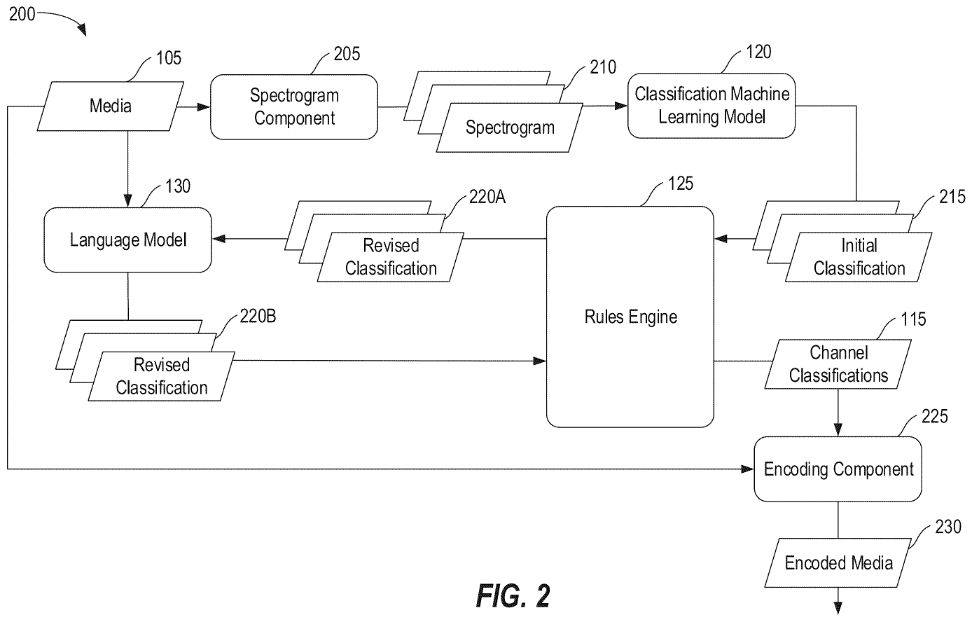

FIG. 2 depicts an example workflow 200 for automatic audio channel classification, according to some embodiments of the present disclosure. In some embodiments, the workflow 200 is performed by an audio classification system, such as the audio classification system 110 of FIG. 1.

In the illustrated example, the media 105 is accessed by a spectrogram component 205 which generates a set of spectrograms 210. In some embodiments, as discussed above, the spectrogram component 205 generates one or more spectrograms for each channel of audio data included in the media 105. That is, for each audio channel, the spectrogram component 205 may extract a corresponding set of audio data and generate a corresponding spectrogram 210. In some embodiments, as discussed above, the spectrogram component 205 may generate a set of spectrograms for each channel.

For example, in some embodiments, the spectrogram component 205 may generate a set of segments of a defined length (e.g., two or more segments collectively covering the first N minutes of the media 105, such as the first thirty minutes) for each audio channel, and may generate a corresponding segment-specific spectrogram 210 for each segment.

As illustrated, the spectrograms 210 are each evaluated using the classification machine learning model 120 to generate a set of initial classifications 215 (also referred to as initial channel classifications in some embodiments). For example, as discussed above, each spectrogram 210 may be separately used as input to the classification machine learning model 120 (e.g., in sequence or in parallel) to generate a corresponding initial classification 215. In some embodiments, if multiple segments are generated for each audio channel, the audio classification system may generate a set of segment classifications (one for each segment).

The set of segment classifications for a given channel may then be combined or aggregated to generate the initial classification 215 for the given channel. Generally, a variety of aggregation operations may be used, such as majority voting (e.g., where the initial classification 215 for the channel is the most frequent segment classification of the set of segment classifications for the channel).

Generally, the classification machine learning model 120 may use a variety of model architectures depending on the particular implementation. For example, in some embodiments, the classification machine learning model 120 may use an architecture configured for time-series analysis, such as a gated recurrence unit (GRU) based model.

In the illustrated workflow 200, the initial classifications 215 (which may include a respective initial classification for each respective channel in the audio data) are then evaluated using the rules engine 125 to generate a set of revised classifications 220A. For example, as discussed above, the rules engine 125 may use a set of predefined rules or heuristics to evaluate each initial classification 215 in isolation, in the context of one or more other initial classifications 215, or both in isolation and in context of other initial classifications in order to determine whether each is plausible (e.g., because it does not violate any of the rules) or possibly incorrect (e.g., because it violates at least one rule).

In some embodiments, the rules engine 125 may generate the revised classifications 220A by optionally modifying one or more of the initial classifications 215 in accordance with the rules. For example, one or more rules may specify to change one or more of the initial classifications 215 to a specified channel classification if the rule is satisfied (e.g., replacing two “stereo right” classifications with a “stereo left” classification and a “stereo right” classification). As another example, if one or more rules indicate that a given initial classification 215 is not plausible or is possibly incorrect (e.g., because only two non-adjacent channels are classified as 5.1) and no rules apply to provide an alternative classification for these channels, the audio classification system may replace the initial classification of such channels with an “unknown” classification.

As illustrated, some or all of the revised classifications 220A are then evaluated using the language model 130. For example, in some embodiments, the audio classification system may identify any revised classifications 220A having a value of “unknown,” and may further evaluate these classifications using the language model 130. In some embodiments, revised classifications 220A having values other than “unknown” may bypass evaluation using the language model 130, thereby reducing computational expense of the audio classification system and increasing the accuracy of the classifications.

In some embodiments, as discussed above, the audio classification system may identify any text label(s) associated with the audio data, and may use this text as context for the language model 130. As one example, the audio classification system may identify a metadata label associated with the media 105 that indicates various features or characteristics of the media 105, such as the title of the media 105, the duration, the audio formatting, the video formatting, the date recorded, the date generated, the contents of the media 105 (e.g., the characters present, a description of events that occur, etc.), and the like.

As another example, the audio classification system may identify one or more title cards (also referred to as slates) included in one or more frames of video data of the media 105 (e.g., physical slates held in front of the camera at the start of filming, or computer generated slates inserted at the beginning of the video data) using various computer vision techniques. Such title or slate cards may include or specify various features or characteristics of the media 105, as discussed above (e.g., the title or name, duration, formatting, and the like). For any such title or slate cards, the audio classification system may use techniques such as optical character recognition (OCR) to extract the textual content of the slate. This text may then be used as the input context for the language model 130.

In some embodiments, given the extracted context, the language model 130 may be prompted to generate a revised classification 220B for each “unknown” label in the set of revised classifications 220A. For example, given the input context, the language model 130 may be prompted with natural language queries such as “what audio data is contained in channel 4 of the media 105?”

As illustrated, the resulting set of revised classifications 220B (which may correspond to the revised classifications 220A with any “unknown” labels removed) are then provided to the rules engine 125 for a second heuristics-based evaluation. In some embodiments, the rules engine 125 may use the same set of rules discussed above to perform a second evaluation on the revised classifications 220B in order to generate the final output set of channel classifications 115.

In the workflow 200, the channel classifications 115 are then used, by an encoding component 225 (which also receives the media 105 itself) to generate an output encoded media 230 (e.g., some or all of the media 105 encoded or formatted according to a desired or target format or encoding). For example, as discussed above, the encoding component 225 may encode the audio data to a target format for improved use in various environments, such as in a stereo format for streaming to mobile devices, in a 5.1 surround sound format for output via home theater systems, and the like.

Although the illustrated example depicts encoding the media 105 to a target format based on the channel classifications 115 as one example, the channel classifications 115 may generally be used to implement, facilitate, or enable a wide variety of downstream processing for the media 105, as discussed above.

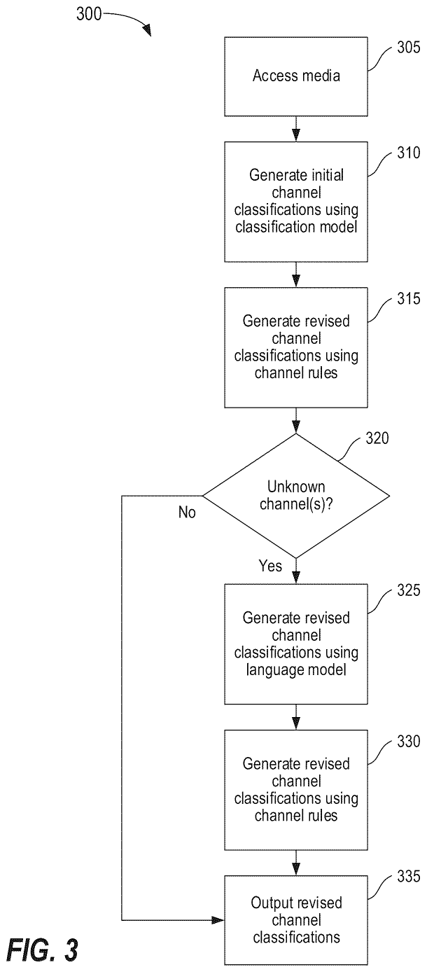

FIG. 3 is a flow diagram depicting an example method 300 for automatic audio channel classification, according to some embodiments of the present disclosure. In some embodiments, the method 300 is performed by an audio classification system, such as the audio classification system 110 of FIG. 1 or the audio classification system discussed above with reference to FIG. 2.

At block 305, the audio classification system accesses media (e.g., one or more media files), such as the media 105 of FIGS. 1-2. In some embodiments, as discussed above, the media includes at least audio data (e.g., audio recorded in one or more channels). As discussed above, the audio data may be formatted using any formatting or encoding (e.g., the audio may be distributed across any number of channels). In some embodiments, as discussed above, the media may also include video data (e.g., a sequence of frames). In some embodiments, as discussed above, the media may also include (or be associated with) one or more tags or labels (e.g., as metadata for the media) indicating various characteristics or features of the media.

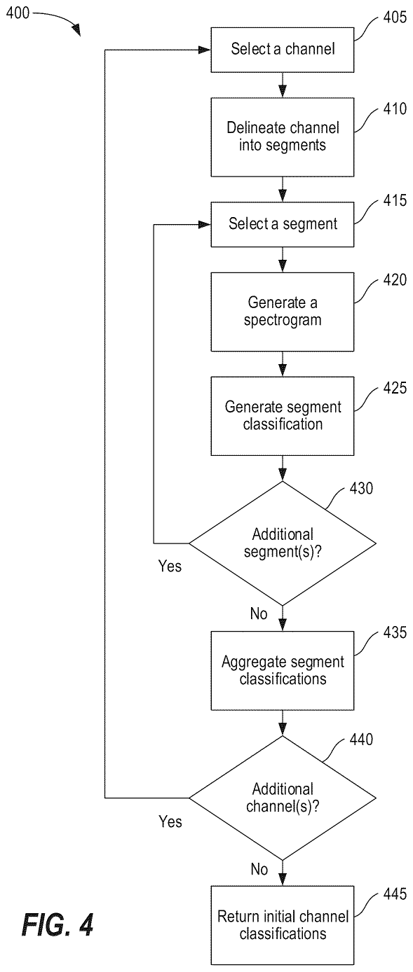

At block 310, the audio classification system generates an initial set of channel classifications (also referred to as a set of initial channel classifications in some aspects) using a classification machine learning model. For example, the audio classification system may evaluate the audio corresponding to each respective channel (e.g., using the classification machine learning model 120 of FIGS. 1-2) to generate a corresponding initial classification (e.g., the initial classifications 215 of FIG. 2) for the respective channel. One example method for generating the initial classifications is discussed in more detail below with reference to FIG. 4.

At block 315, the audio classification system generates a revised set of channel classifications (e.g., the revised classifications 220A of FIG. 2, also referred to in some embodiments as a set of revised channel classifications) using one or more channel rules (e.g., using the rules engine 125 of FIGS. 1-2). For example, as discussed above, the audio classification system may determine whether the initial set of classifications violates any of a defined set of rules (e.g., indicating that one or more of the classifications are implausible or incorrect). In some embodiments, in addition to or instead of specifying criteria or conditions that would cause a classification to be deemed incorrect, one or more of the rules may provide a “correct” classification for one or more channels. For example, as discussed above, one rule may indicate that at most one channel can be classified as “mono mix” (such that if two or more channels are classified as mono mix, each is determined to be incorrect), while a second rule may indicate that if two adjacent channels are both classified as “stereo,” the first should be classified as “stereo left” and the second should be classified as “stereo right.” In some embodiments, as discussed above, if it is determined that the initial classification of a given channel violates one or more rules and that no alternative classification is applicable to the given channel (based on the set of rules), the given channel may be labeled as “unknown” or another similar classification.

At block 320, the audio classification system determines whether at least one of the channels is indicated as “unknown” in the revised set of channel classifications. If not (e.g., if all of the channels in the audio data have a valid label that satisfies the set of rules), the method 300 continues to block 335, discussed in more detail below. That is, if the initial classifications and rules-based evaluations result in a valid set of channel classifications, the audio classification system may refrain from further evaluation or processing of the data, resulting in reduced computational expense.

For example, as discussed above and in more detail below, in some aspects, the audio classification system may use additional machine learning models (such as LLMs) to perform further analysis. However, this analysis may introduce additional computational overhead. Accordingly, in some embodiments, the audio classification system may perform this additional evaluation only selectively or adaptively (e.g., only when the initial analysis indicates a need for further review). When the initial evaluations result in a valid output, the audio classification system may refrain from the further analysis, thereby reducing the computational expense of the audio classification system.

If, at block 320, the audio classification system determines that one or more of the audio channels have an unknown classification, the method 300 continues to block 325. At block 325, the audio classification system generates a second revised set of channel classifications (e.g., the revised classifications 220B of FIG. 2) using a language model (e.g., the language model 130 of FIGS. 1-2).

For example, as discussed above, the audio classification system may identify one or more textual descriptions for the media (which may include various descriptions of the media, including the purported audio formatting). This text may then be used as context for the language model, allowing the audio classification system to prompt the language model to generate a label for each “unknown” channel (e.g., “based on this context, what audio data does channel 4 contain?”). In some embodiments, as discussed above, the audio classification system may use one or more models or other techniques to identify title or slate cards in the video data of the media, and may use techniques such as OCR to extract the textual context.

In some embodiments, as discussed above, the audio classification system may only prompt the language model to generate classifications for any “unknown” channels. That is, channels having a valid classification (e.g., classifications generated by the classification model and verified as at least plausible because they do not violate any of the rules) may forgo this further language model processing, reducing expense and improving output accuracy.

At block 330, the audio classification system can generate a third revised set of channel classifications (e.g., the channel classifications 115 of FIGS. 1-2) based on evaluating the second set of revised classifications (generated using the language model) using the set of rules (e.g., the rules engine 125), as discussed above. In some aspects, this second rules-based evaluation similarly evaluates the entire set of revised classifications, including those generated by the language model and those previously generated by the classification model, those generated using rules (e.g., because the plausibility of a given label generated by the language model may depend in part on the labels of the surrounding channels), or both. In some embodiments, as discussed above, application of these rules may result in the classification for one or more channels to be changed (e.g., to “unknown” or to a different known label).

At block 335, the audio classification system then outputs the revised channel classifications (which may include “unknown” labels). As discussed above, outputting the channel classifications can generally include a variety of operations, such as outputting the classifications for display or verification (e.g., by a user). In some embodiments, the audio classification system may output the classifications for verification only if one or more “unknown” labels remain. In some embodiments, outputting the revised channel classifications can include storing the revised channel classifications (e.g., as metadata associated with the media) for future review or use.

In some embodiments, outputting the revised channel classifications for user review can allow the user (e.g., an editor) to readily and efficiently identify which track(s) to use or select for a wide variety of editing or post-production tasks.

In some embodiments, the audio classification system may use the channel classifications to facilitate further processing of the media, such as to convert, encode, or both convert and encode the media (including the audio data) into a different format or encoding (e.g., to facilitate efficient storage, streaming, or other use of the media).

FIG. 4 is a flow diagram depicting an example method 400 for machine learning-based channel classification, according to some embodiments of the present disclosure. In some embodiments, the method 400 is performed by an audio classification system, such as the audio classification system 110 of FIG. 1 or the audio classification system discussed above with reference to FIGS. 2-3. In some embodiments, the method 400 provides additional detail for block 310 of FIG. 3.

At block 405, the audio classification system selects a channel from the audio data included in the received media. That is, as discussed above, the audio data may be represented in one or more discrete channels (e.g., where each channel has a component or portion of the overall audio of the media). Generally, the audio classification system may select the channel using any suitable technique, including sequentially (e.g., based on the channel indices in the audio), randomly, or pseudo-randomly, as all of the audio channels may be processed during the method 400.

At block 410, the audio classification system delineates the audio data contained in the selected channel into a set of one or more segments. For example, as discussed above, the audio classification system may generate one or more segments having a defined duration (e.g., the same duration as the media that was used to train the classification model). In some embodiments, if the audio in the selected channel cannot be evenly divided into such defined durations (e.g., if the audio is 45 minutes long and the desired segment duration is twenty minutes), the audio classification system may discard or otherwise refrain from processing the additional audio data (e.g., the last five minutes). In some embodiments, the audio classification system generates a defined number of segments (e.g., one segment, five segments, and the like) even if additional data remains. For example, if the segment duration is five minutes and the audio is sixty minutes long, twelve segments could be generated but the audio classification system may instead generate five (or some other fixed amount) and discard the remaining audio.

At block 415, the audio classification system selects one of the delineated segments of audio data from the selected channel. Generally, the audio classification system may select the segment using any suitable technique, including randomly or pseudo-randomly, as all of the audio segments may be processed during the method 400.

At block 420, the audio classification system generates a spectrogram of the audio data included in the selected segment. For example, the audio classification system may use techniques such as fast-Fourier transforms (short-time Fourier Transformation (STFT) on the segment to transform the audio data from the time domain to the frequency domain.

At block 425, the audio classification system generates a segment classification based on processing the segment spectrogram (generated at block 420) using the trained channel classification model, as discussed above.

At block 430, the audio classification system determines whether there is at least one additional segment from the selected channel that remains to be processed. If so, the method 400 returns to block 415. If not, the method 400 continues to block 435. Although the illustrated example depicts an iterative process (selecting and evaluating each segment in sequence) for conceptual clarify, in some embodiments, the audio classification system may evaluate some or all of the segments entirely or partially in parallel.

At block 435, the audio classification system aggregates the segment classifications for the selected channel to generate an overall prediction (e.g., an initial classification 215 of FIG. 2) for the selected channel. For example, as discussed above, the aggregated classification may correspond to the most common segment classification (from the set of segment classifications for the channel). The audio classification system may generally use a variety of techniques to aggregate the segment classifications.

At block 440, the audio classification system determines whether there is at least one channel, from the audio data, remaining to be evaluated. If so, the method 400 returns to block 405. If not, the method 400 continues to block 445. Although the illustrated example depicts an iterative process (selecting and evaluating each channel in sequence) for conceptual clarify, in some embodiments, the audio classification system may evaluate some or all of the channels entirely or partially in parallel.

At block 445, the audio classification system returns the initial set of channel classifications. For example, as discussed above, the audio classification system may then use the initial classifications as input to a rules-based analysis (e.g., using the rules engine 125 of FIGS. 1-2) to further refine the channel classifications.

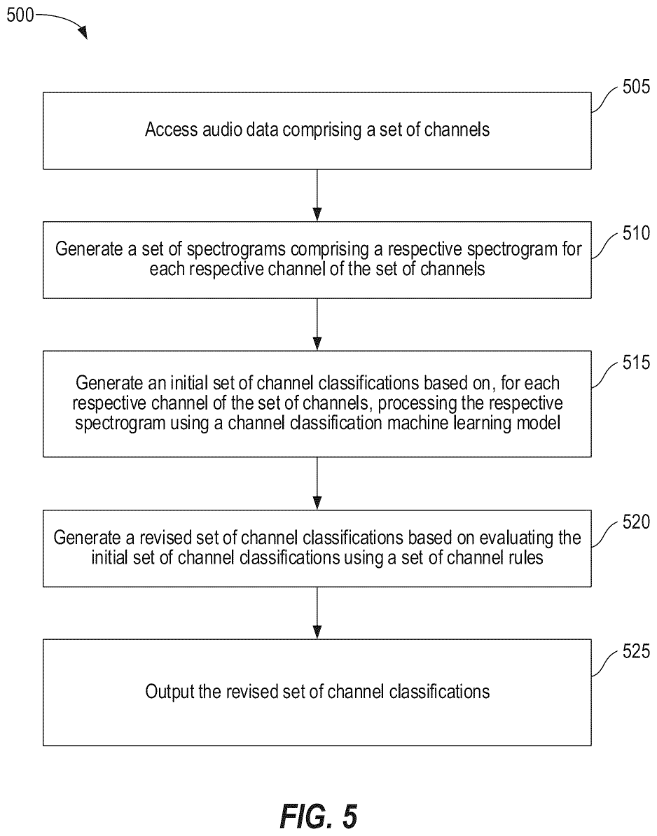

FIG. 5 is a flow diagram depicting an example method 500 for channel classification, according to some embodiments of the present disclosure. In some embodiments, the method 500 is performed by an audio classification system, such as the audio classification system 110 of FIG. 1 or the audio classification system discussed above with reference to FIGS. 2-4.

At block 505, audio data (e.g., the media 105 of FIGS. 1-2) comprising a set of channels is accessed.

At block 510, a set of spectrograms (e.g., the spectrograms 210 of FIG. 2) comprising a respective spectrogram for each respective channel of the set of channels is generated.

At block 515, an initial set of channel classifications (e.g., the initial classifications 215 of FIG. 2) is generated based on, for each respective channel of the set of channels, processing the respective spectrogram using a channel classification machine learning model (e.g., the classification machine learning model 120 of FIGS. 1-2).

At block 520, a revised set of channel classifications (e.g., the revised classifications 220A or the revised classifications 220B of FIGS. 1-2, or the channel classifications 115 of FIGS. 1-2) is generated based on evaluating the initial set of channel classifications using a set of channel rules (e.g., the rules engine 125 of FIGS. 1-2).

At block 525, the revised set of channel classifications is outputted.

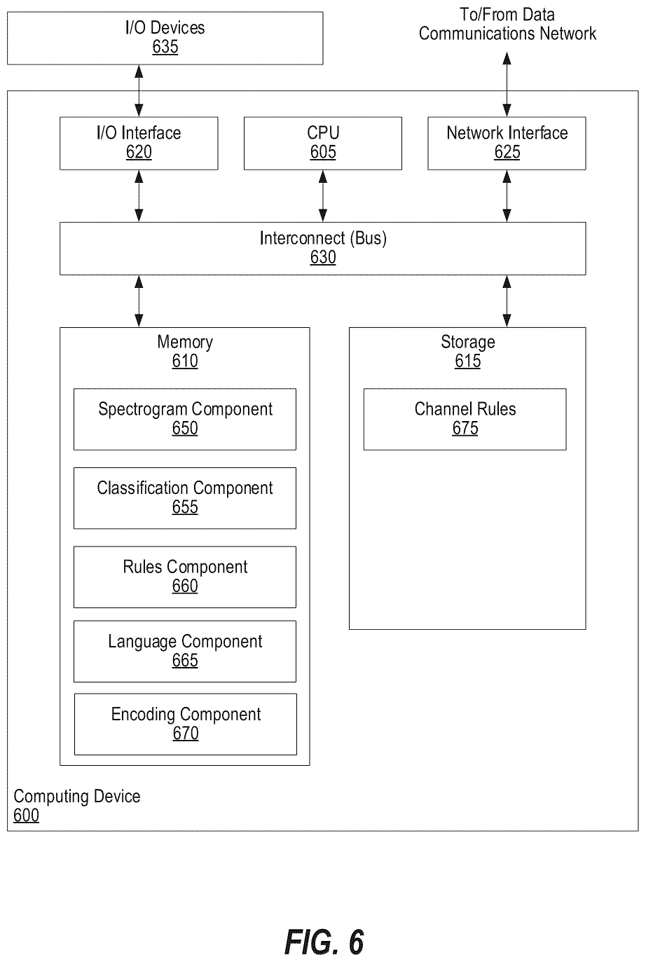

FIG. 6 depicts an example computing device 600 configured to perform various embodiments of the present disclosure. Although depicted as a physical device, in embodiments, the computing device 600 may be implemented using any number of virtual or physical device(s) (e.g., in a cloud environment). In one embodiment, the computing device 600 corresponds to or implements an audio classification system, such as the audio classification system 110 of FIG. 1 or the audio classification system discussed above with reference to FIGS. 2-5.

As illustrated, the computing device 600 includes a CPU 605, memory 610, a network interface 625, and one or more I/O interfaces 620. Though not included in the depicted example, in some embodiments, the computing device 600 also includes one or more storages. In the illustrated embodiment, the CPU 605 retrieves and executes programming instructions stored in memory 610, as well as stores and retrieves application data residing in memory 610, storage (not depicted), or both. The CPU 605 is generally representative of a single CPU, a single GPU, multiple CPUs, multiple GPUs, a single CPU having multiple processing cores, a single GPU having multiple processing cores, and the like. The memory 610 is generally included to be representative of a random access memory. In an embodiment, if storage is present, it may include any combination of disk drives, flash-based storage devices, and the like, and may include fixed storage devices, removable storage devices, or both (such as fixed disk drives, removable memory cards, caches, optical storage, network attached storage (NAS), or storage area networks (SAN)).

In some embodiments, I/O devices 635 (such as keyboards, monitors, etc.) are connected via the I/O interface(s) 620. Further, via the network interface 625, the computing device 600 can be communicatively coupled with one or more other devices and components (e.g., via a network, which may include the Internet, local network(s), and the like). As illustrated, the CPU 605, memory 610, network interface(s) 625, and I/O interface(s) 620 are communicatively coupled by one or more buses 630.

In the illustrated embodiment, the memory 610 includes a spectrogram component 650, a classification component 655, a rules component 660, a language component 665, and an encoding component 670, which may perform one or more embodiments discussed above. Although depicted as discrete components for conceptual clarity, in embodiments, the operations of the depicted components (and others not illustrated) may be combined or distributed across any number of components. Further, although depicted as software residing in memory 610, in embodiments, the operations of the depicted components (and others not illustrated) may be implemented using hardware, software, or a combination of hardware and software.

The spectrogram component 650 (which may correspond to the spectrogram component 205 of FIG. 2) may generally be used to generate spectrograms (e.g., the spectrograms 210 of FIG. 2) for input audio data to facilitate machine learning evaluations, as discussed above. For example, the spectrogram component 650 may use Fourier transforms to generate one or more spectrograms for each channel (e.g., for each segment of each channel).

The classification component 655 (which may correspond to the classification machine learning model 120 of FIGS. 1-2) may generally be used to classify each audio channel based on the corresponding spectrogram(s), as discussed above. For example, the classification component 655 may evaluate the spectrogram(s) using trained machine learning models (e.g., classification models), as discussed above (e.g., to generate the initial classifications 215 of FIG. 2).

The rules component 660 (which may correspond to the rules engine 125 of FIGS. 1-2) may generally be used to validate, modify, or validate and modify channel classifications based on a defined set of rules or heuristics (e.g., the channel rules 675), as discussed above. For example, the rules component 660 determine whether any of the classifications are invalid or (potentially) incorrect. In some embodiments, the rules component 660 may generate a new label (which may include an “unknown” label) for any channels that are found to violate one or more of the rules (e.g., to generate the revised classifications 220A of FIG. 2).

The language component 665 component (which may correspond to the language model 130 of FIGS. 1-2) may generally be used to generate a second set of revised classifications, as discussed above. For example, the language component 665 component may use one or more language models to evaluate textual context associated with the media in order to generate a new label for any channels currently designated as “unknown” (e.g., to generate the set of revised classifications 220B of FIG. 2). In some embodiments, as discussed above, these revised classifications may then be further evaluated by the rules component 660 to generate the final output classifications.

The encoding component 670 (which may correspond to the encoding component 225 of FIG. 2) may generally be used to encode, format, transform, or otherwise process the media based on the generated channel classifications, as discussed above. For example, the encoding component 670 may reformat the audio (from the determined channel format to a target format), re-encode the audio or media, or both reformat and re-encode the audio or media in order to facilitate various downstream tasks, as discussed above.

In the illustrated example, the storage 615 includes a set of channel rules 675 (which may be used by the rules component 660). Although depicted as residing in storage 615, the depicted data may be stored in any suitable location. Generally, the channel rules 675 may comprise a set of definitions or heuristics used to determine whether a given set of classifications is valid (e.g., plausible) or contains one or more errors (e.g., such that at least one of the classifications is incorrect).

In the current disclosure, reference is made to various embodiments. However, it should be understood that the present disclosure is not limited to specific described embodiments. Instead, any combination of the following features and elements, whether related to different embodiments or not, is contemplated to implement and practice the teachings provided herein. Additionally, when elements of the embodiments are described in the form of “at least one of A and B,” it will be understood that embodiments including element A exclusively, including element B exclusively, and including element A and B are each contemplated. Furthermore, although some embodiments may achieve advantages over other possible solutions or over the prior art, whether or not a particular advantage is achieved by a given embodiment is not limiting of the present disclosure. Thus, the aspects, features, embodiments and advantages disclosed herein are merely illustrative and are not considered elements or limitations of the appended claims except where explicitly recited in a claim(s). Likewise, reference to “the invention” shall not be construed as a generalization of any inventive subject matter disclosed herein and shall not be considered to be an element or limitation of the appended claims except where explicitly recited in a claim(s).

As will be appreciated by one skilled in the art, embodiments described herein may be embodied as a system, method or computer program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments described herein may take the form of a computer program product embodied in one or more computer readable medium(s) having computer readable program code embodied thereon.

Program code embodied on a computer readable medium may be transmitted using any appropriate medium, including but not limited to wireless, wireline, optical fiber cable, RF, etc., or any suitable combination of the foregoing.

Computer program code for carrying out operations for embodiments of the present disclosure may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present disclosure are described herein with reference to flowchart illustrations or block diagrams of methods, apparatuses (systems), and computer program products according to embodiments of the present disclosure. It will be understood that each block of the flowchart illustrations or block diagrams, and combinations of blocks in the flowchart illustrations or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the block(s) of the flowchart illustrations or block diagrams.

These computer program instructions may also be stored in a computer readable medium that can direct a computer, other programmable data processing apparatus, or other device to function in a particular manner, such that the instructions stored in the computer readable medium produce an article of manufacture including instructions which implement the function/act specified in the block(s) of the flowchart illustrations or block diagrams.

The computer program instructions may also be loaded onto a computer, other programmable data processing apparatus, or other device to cause a series of operational steps to be performed on the computer, other programmable apparatus or other device to produce a computer implemented process such that the instructions which execute on the computer, other programmable data processing apparatus, or other device provide processes for implementing the functions/acts specified in the block(s) of the flowchart illustrations or block diagrams.

The flowchart illustrations and block diagrams in the Figures illustrate the architecture, functionality, and operation of possible implementations of systems, methods, and computer program products according to various embodiments of the present disclosure. In this regard, each block in the flowchart illustrations or block diagrams may represent a module, segment, or portion of code, which comprises one or more executable instructions for implementing the specified logical function(s). It should also be noted that, in some alternative implementations, the functions noted in the block may occur out of the order noted in the Figures. For example, two blocks shown in succession may, in fact, be executed substantially concurrently, or the blocks may sometimes be executed in the reverse order or out of order, depending upon the functionality involved. It will also be noted that each block of the block diagrams or flowchart illustrations, and combinations of blocks in the block diagrams or flowchart illustrations, can be implemented by special purpose hardware-based systems that perform the specified functions or acts, or combinations of special purpose hardware and computer instructions.

While the foregoing is directed to embodiments of the present disclosure, other and further embodiments of the disclosure may be devised without departing from the basic scope thereof, and the scope thereof is determined by the claims that follow.

What is claimed is:

1. A method, comprising:
accessing audio data comprising a set of channels;
generating a set of spectrograms comprising a respective spectrogram for each respective channel of the set of channels;
generating an initial set of channel classifications based on, for each respective channel of the set of channels, processing the respective spectrogram using a channel classification machine learning model;
generating a revised set of channel classifications based on evaluating the initial set of channel classifications using a set of channel rules; and
outputting the revised set of channel classifications.

2. The method of claim 1, wherein generating the revised set of channel classifications comprises:
determining that a first channel classification for a first channel, of the set of channels, is incorrect based on at least one channel rule of the set of channel rules; and
modifying the first channel classification.

3. The method of claim 2, wherein modifying the first channel classification comprises determining a new channel classification for the first channel based on the at least one channel rule.

4. The method of claim 3, wherein determining the new channel classification comprises evaluating one or more channel classifications of one or more adjacent channels in the set of channels.

5. The method of claim 2, wherein modifying the first channel classification comprises determining that the first channel has an unknown channel classification.

6. The method of claim 5, wherein modifying the first channel classification further comprises evaluating text data associated with the audio data using a language model (LM) to determine a new channel classification for the first channel.

7. The method of claim 6, further comprising:
identifying a frame, from video data associated with the audio data, comprising text; and
extracting the text data from the frame using one or more optical character recognition (OCR) techniques.

8. The method of claim 6, further comprising determining that the new channel classification is plausible based on at least one channel rule of the set of channel rules.

9. The method of claim 1, further comprising:
determining that a first channel classification for a first channel, of the set of channels, is plausible based on at least one channel rule of the set of channel rules; and
refraining from further evaluation of the first channel.

10. The method of claim 1, wherein generating the set of spectrograms comprises, for a first channel of the set of channels:
delineating audio of the first channel into a set of segments; and
generating a set of spectrograms for the set of segments.

11. The method of claim 10, wherein generating the initial set of channel classifications comprises, for the first channel of the set of channels:
generating a set of segment classifications based on processing the set of spectrograms using the channel classification machine learning model; and
aggregating the set of segment classifications to generate an initial channel classification for the first channel.

12. The method of claim 1, wherein outputting the revised set of channel classifications comprises generating an encoded version of the audio data based on the revised set of channel classifications.

13. One or more non-transitory computer readable media containing, in any combination, computer program code that, when executed by operation of any combination of one or more processors, performs an operation comprising:
accessing audio data comprising a set of channels;
generating a set of spectrograms comprising a respective spectrogram for each respective channel of the set of channels;
generating an initial set of channel classifications based on, for each respective channel of the set of channels, processing the respective spectrogram using a channel classification machine learning model;
generating a revised set of channel classifications based on evaluating the initial set of channel classifications using a set of channel rules; and
outputting the revised set of channel classifications.

14. The one or more non-transitory computer readable media of claim 13, wherein generating the revised set of channel classifications comprises:
determining that a first channel classification for a first channel, of the set of channels, is incorrect based on at least one channel rule of the set of channel rules; and
modifying the first channel classification.

15. The one or more non-transitory computer readable media of claim 14, wherein modifying the first channel classification comprises evaluating text data associated with the audio data using a language model (LM) to determine a new channel classification for the first channel.

16. The one or more non-transitory computer readable media of claim 13, the operation further comprising:
determining that a first channel classification for a first channel, of the set of channels, is plausible based on at least one channel rule of the set of channel rules; and
refraining from further evaluation of the first channel.

17. A system, comprising:
one or more processors; and
one or more memories storing a program, which, when executed on any combination of the one or more processors, performs operations, the operations comprising:
accessing audio data comprising a set of channels;
generating a set of spectrograms comprising a respective spectrogram for each respective channel of the set of channels;
generating an initial set of channel classifications based on, for each respective channel of the set of channels, processing the respective spectrogram using a channel classification machine learning model;
generating a revised set of channel classifications based on evaluating the initial set of channel classifications using a set of channel rules; and
outputting the revised set of channel classifications.

18. The system of claim 17, wherein generating the revised set of channel classifications comprises:
determining that a first channel classification for a first channel, of the set of channels, is incorrect based on at least one channel rule of the set of channel rules; and
modifying the first channel classification.

19. The system of claim 18, wherein modifying the first channel classification comprises evaluating text data associated with the audio data using a language model (LM) to determine a new channel classification for the first channel.

20. The system of claim 17, the operation further comprising:
determining that a first channel classification for a first channel, of the set of channels, is plausible based on at least one channel rule of the set of channel rules; and
refraining from further evaluation of the first channel.
